(19) United States
(12) Patent Application Publication
(10) Pub. No.: US 2025/0006890 A1
(43) Pub. Date: Jan. 2, 2025

(54) COMPOSITIONS AND METHODS FOR PREPARING BATTERY ELECTRODES

(71) Applicant: Aspen Aerogels, Inc., Northborough, MA (US)

(72) Inventors: John Bushman, Natick, MA (US); Thomas Carney, Framingham, MA (US)

(73) Assignee: Aspen Aerogels, Inc., Northborough, MA (US)

(21) Appl. No.: 18/829,554

(22) Filed: Sep. 10, 2024

Related U.S. Application Data
(63) Continuation of application No. PCT/US2023/016820, filed on Mar. 30, 2023.
(60) Provisional application No. 63/326,474, filed on Apr. 1, 2022.

(51) Int. Cl. H01M 4/133; H01M 4/02; H01M 4/587; H01M 4/62; H01M 10/0525

(52) U.S. Cl. CPC H01M 4/133; H01M 4/587; H01M 4/622; H01M 4/625; H01M 10/0525; H01M 2004/021; H01M 2004/027

(57) ABSTRACT

The present disclosure is directed to lithium-ion battery anodes and components thereof. Further provided are processes for the preparation of lithium-ion battery anodes. Such processes generally include preparation of a slurry including an anode material, a binder material, a conductive material, and a solvent. The anode material includes a carbon-silicon composite, and optionally, graphite.

### CROSS REFERENCES TO RELATED APPLICATIONS

This application is a continuation of International PCT Application No. PC/US2023/016820 filed Mar. 30, 2023, entitled “Compositions and Methods for Preparing Battery Electrodes” which claims priority to and the benefit of U.S. Provisional Patent Application No. 63/326,474 filed Apr. 1, 2022, entitled “Compositions and Methods for Preparing Battery Electrodes” which is herein incorporated by reference in its entirety.

### TECHNICAL FIELD

The present disclosure relates generally to lithium-ion battery anodes and the preparation thereof, as well as batteries including such anodes.

### BACKGROUND

Lithium-ion batteries (LIBs) have seen widespread use in a variety of applications, from handheld electronics to automobiles. They are a type of rechargeable battery in which lithium ions travel from an anode to a cathode during discharge and from the cathode to the anode during charge. Characteristics of electrodes can dramatically affect the performance and safety characteristics of LIBs. Conventionally, the cathode active material of LIBs is comprised of mixed metal oxides of lithium, e.g., cobalt, nickel, manganese, while the anode active material comprises carbon-based material, such as mesocarbon microbeads and graphite. Graphite is widely used as an anode active material owing to its high specific capacity, low electrochemical potential vs. lithium, and ability for form a stable Solid Electrolyte Interphase (SEI). Nevertheless, there is a commercial demand for lithium-ion battery anode materials that have a higher lithium storage capacity than is obtainable with graphite.

Silicon (Si) has a lithium storage capacity greater than graphite and low electrochemical potential vs lithium, making it desirable for LIB anodes. Accordingly, there is a desire to dispose as much silicon as possible within the anode. However, during cycling, conventional silicon materials undergo volumetric expansion and contraction due to insertion and removal of lithium ions. These stresses can lead to fracture of the silicon material, potentially leading to pulverization of the anode and a decrease in the service life of the LIB.

Accordingly, it would be desirable in the art to provide silicon-containing anode materials which maintain low electrical resistance and accommodate silicon expansion without causing the coated electrode to crack and delaminate. Further, it would be desirable in the art to provide methods for preparing improved LIB anodes comprising such anode materials.

### SUMMARY

The present technology is generally directed to lithium-ion battery anodes and methods of preparation thereof, as well as batteries comprising such anodes. Specifically, the technology is directed to preparation and use of lithium-ion battery anode slurries comprising anode active materials comprising a carbon-silicon composite, one or more binder materials, one or more conductive additive materials, and a solvent.

Accordingly, in one aspect is provided a slurry for preparation of a lithium-ion battery anode, the slurry having a viscosity in a range from about 500 mPa·s to about 3500 mPa·s, the slurry comprising:
75-90% by weight of an anode active material comprising a carbon-silicon composite having a surface area in a range from about 3 to about 75 m²/g;
5-15% by weight of a binder material;
1-10% by weight of a conductive material; and
a solvent, wherein all percent by weight values are on a dry weight basis and are based on the total weight of the slurry after removal of the solvent.

In some aspects, the viscosity of the slurry is in a range from about 1300 to about 1700 mPa·s at a shear rate of about 167/s.

In some aspects, the carbon-silicon composite has a surface area in a range from about 1 m²/g to about 400 m²/g.

In some aspects, the carbon-silicon composite has a tap density in a range from about 0.3 g/cm³ to about 1.3 g/cm³.

In some aspects, the carbon-silicon composite comprises silicon in an amount by weight greater than about 10%, based on the total weight of the carbon-silicon composite. In some aspects, the carbon-silicon composite comprises silicon in a range from about 20% by weight to about 85% by weight, based on the total weight of the carbon-silicon composite. In some aspects, the carbon-silicon composite comprises silicon in a range from about 20 to about 55%, or from about 30% by weight to about 35% by weight, based on the total weight of the carbon-silicon composite.

In some aspects, the carbon-silicon composite is an aerogel, a xerogel, a cryogel, or an ambigel. In some aspects, the carbon-silicon composite comprises a carbonized polyimide aerogel. In some aspects, the carbon-silicon composite comprises a pore structure, the pore structure comprising a fibrillar morphology and an array of pores surrounding elemental silicon.

In some aspects, the silicon in the carbon-silicon composite is present in particulate form, the particles having an average particle size of about 1 μm or less.

In some aspects, the carbon-silicon composite has a specific capacity of at least 400 mAh/g, or at least 1000 mAh/g.

In some aspects, the anode active material has a particle size D90 value of less than or equal to 40 μm. In some aspects, the anode active material has a particle size D50 in a range from about 5 μm to about 20 μm. In some aspects, the anode active material has a particle size D10 value of at least 1 μm.

In some aspects, a percentage of solids in the slurry is in a range from about 30% to about 35% by weight. In some aspects, a percentage of solids in the slurry is in a range from about 35% to about 60% by weight. In some aspects, a percentage of solids in the slurry is in a range from about 45% to about 50% by weight.

In some aspects, the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

In some aspects, the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, cyanoethylsucrose, fluorinated polymer, chlorinated polymer, a salt of alginic acid, polyvinylidene fluoride, poly(vinylidene fluoride)-hexafluoropropene, and combinations thereof. In some aspects, the binder material is selected from the group consisting of styrene-butadiene rubber, acrylated styrene-butadiene rubber, polyacrylonitrile, polyacrylic acid, lithiated polyacrylic acid, ammonia polyacrylic acid, polyvinylidene fluoride, and combinations thereof. In some aspects, the binder material is polyacrylic acid.

In some aspects, the solvent is selected from the group consisting of N-methyl-2-pyrrolidone, dimethylformamide, dimethyl sulfoxide, acetonitrile, butylene carbonate, propylene carbonate, ethyl bromide, tetrahydrofuran, dimethyl carbonate, diethyl carbonate, ethyl methyl, carbonate methyl propyl carbonate, ethylene carbonate, water, ethanol, isopropanol, methanol, acetone, n-propanol, t-butanol, and combinations thereof. In some aspects, the solvent is selected from the group consisting of N-methyl-2-pyrrolidone, dimethylformamide, water, and combinations thereof. In some aspects, the solvent is water.

In some aspects, a pH value of the slurry is from about 6 to about 8.

In another aspect is provided a lithium-ion battery anode slurry having a viscosity in a range from about 500 mPa·s to about 3500 mPa·s, the slurry comprising:
80-95% by weight of an anode active material comprising (i) a carbon-silicon composite having a surface area in a range from about 3 to about 75 m²/g, and (ii) a carbon active material;
2-15% by weight of a binder material;
0.5-10% by weight of a conductive material; and
a solvent, wherein all percent by weight values are on a dry weight basis and are based on the total weight of the slurry.

In some aspects, the viscosity of the slurry is in a range from about 1300 to about 1700 mPa·s at a shear rate of about 167/s.

In some aspects, the graphite has a surface area of 3 to 5 m²/g and a particle size D50 value of about 12 μm.

In some aspects, the anode active material comprises a ratio of about 80 wt % carbon active material to about 20 wt % carbon-silicon composite.

In some aspects, the carbon-silicon composite comprises silicon in an amount by weight greater than about 10%, based on the total weight of the carbon-silicon composite. In some aspects, the carbon-silicon composite comprises silicon in a range from about 20 by weight to about 85% by weight, or from about 30% by weight to about 55% by weight, based on the total weight of the carbon-silicon composite. In some aspects, the carbon-silicon composite comprises silicon in a range from about 30% by weight to about 35% by weight, based on the total weight of the carbon-silicon composite.

In some aspects, the silicon in the carbon-silicon composite is present in particulate form, the particles having an average particle size of about 1 μm or less.

In some aspects, the carbon-silicon composite is an aerogel, a xerogel, a cryogel, or an ambigel. In some aspects, the carbon-silicon composite comprises a carbonized polyimide aerogel. In some aspects, the carbon-silicon composite comprises a pore structure, the pore structure comprising a fibrillar morphology and an array of pores surrounding elemental silicon.

In some aspects, the carbon-silicon composite has a tap density in a range from about 0.3 g/cm³ to about 1.3 g/cm³.

In some aspects, the carbon-silicon composite has a specific capacity of at least 400 mAh/g.

In some aspects, the anode active material has a particle size D90 value of less than or equal to 40 μm. In some aspects, the anode active material has a particle size D50 in a range from about 5 μm to about 20 μm. In some aspects, the anode active material has a particle size D10 value of at least 1 μm.

In some aspects, a percentage of solids in the slurry is in a range from about 30% to about 35% by weight. In some aspects, a percentage of solids in the slurry is in a range from about 35% to about 60% by weight. In some aspects, a percentage of solids in the slurry is in a range from about 45% to about 50% by weight.

In some aspects, the carbon active material is selected from the group consisting of mesoporous carbon, natural graphite, synthetic graphite, graphite flakes, hard carbon, soft carbon, and combinations thereof.

In some aspects, the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

In some aspects, the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, fluorinated polymer, chlorinated polymer, a salt of alginic acid, polyvinylidene fluoride, poly(vinylidene fluoride)-hexafluoropropene, and combinations thereof. In some aspects, the binder material is selected from the group consisting of styrene-butadiene rubber, acrylated styrene-butadiene rubber, polyacrylonitrile, polyacrylic acid, lithiated polyacrylic acid, ammonia polyacrylic acid, polyvinylidene fluoride, and combinations thereof. In some aspects, the binder material is selected from the group consisting of polyacrylic acid, styrene-butadiene rubber, and combinations thereof.

In some aspects, the binder material is styrene-butadiene rubber, the slurry further comprising a rheology modifier.

In some aspects, the rheology modifier is carboxymethyl cellulose, hydroxypropyl cellulose, cellulose acetate, cellulose acetate butyrate, cellulose acetate propionate, cyanoethylcellulose, or a combination thereof. In some aspects, the rheology modifier is carboxymethyl cellulose.

In some aspects, the solvent is selected from the group consisting of N-methyl-2-pyrrolidone, dimethylformamide, dimethyl sulfoxide, acetonitrile, butylene carbonate, propylene carbonate, ethyl bromide, tetrahydrofuran, dimethyl carbonate, diethyl carbonate, ethyl methyl, carbonate methyl propyl carbonate, ethylene carbonate, water, ethanol, isopropanol, methanol, acetone, n-propanol, t-butanol, and combinations thereof. In some aspects, the solvent is selected from the group consisting of N-methyl-2-pyrrolidone, dimethylformamide, water, and combinations thereof. In some aspects, the solvent is water.

In some aspects, a pH value of the slurry is from about 6 to about 8.

In a further aspect is provided an anode electrode composition comprising:
from about 75 to about 90% by weight of an anode active material comprising a carbon-silicon composite having a surface area in a range from about 3 to about 75 m²/g;
from about 2 to about 20% by weight of a binder material; and
from about 0.5 to about 15% by weight of a conductive material;
wherein all percent by weight values are on a dry weight basis and are based on the total weight of the composition.

In some aspects, the anode active material further comprises graphite.

In some aspects, the anode active material comprises a ratio of about 80 wt % carbon active material to about 20 wt % carbon-silicon composite.

In some aspects, the carbon-silicon composite comprises silicon in a range from about 20% by weight to about 85% by weight, based on the total weight of the carbon-silicon composite.

In some aspects, the silicon in the carbon-silicon composite is present in particulate form, the particles having an average particle size of about 1 μm or less.

In some aspects, the carbon-silicon composite is an aerogel, a xerogel, a cryogel, or an ambigel. In some aspects, the carbon-silicon composite comprises a carbonized polyimide aerogel.

In some aspects, the carbon-silicon composite comprises a pore structure, the pore structure comprising a fibrillar morphology and an array of pores surrounding elemental silicon.

In some aspects, the carbon-silicon composite has a tap density in a range from about 0.3 g/cm³ to about 1.3 g/cm³.

In some aspects, the carbon-silicon composite has a specific capacity of at least 400 mAh/g.

In some aspects, the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

In some aspects, the binder material is styrene-butadiene rubber, the anode electrode composition further comprising a rheology modifier.

In some aspects, the rheology modifier is carboxymethyl cellulose.

In a still further aspect is provided an anode for a lithium-ion battery, the anode comprising:
an anode substrate; and
an anode electrode layer disposed on the anode substrate, wherein the anode electrode layer comprises an anode electrode composition comprising:
from about 75 to about 90% by weight of an anode active material comprising a carbon-silicon composite having a surface area in a range from about 3 to about 75 m²/g;
from about 2 to about 20% by weight of a binder material; and
from about 0.5 to about 15% by weight of a conductive material;
wherein all percent by weight values are on a dry weight basis and are based on the total weight of the composition.

In some aspects, the substrate is a copper film.

In some aspects, the anode electrode layer is loaded on the substrate at a density from 2.5 to about 7 mg/cm².

In some aspects, the anode electrode layer is from about 10 μm to about 300 μm in thickness.

In some aspects, the press density of the anode electrode layer is in a range from about 0.3 to about 1.1 g/cm³.

In some aspects, the areal capacity of the anode electrode layer is 4.5-5.5 mAh/cm². In some aspects, the conductivity of the anode electrode layer is at least about 10 S/cm.

In a still further aspect is provided a lithium-ion battery comprising: a cathode; an anode comprising an anode substrate and an anode electrode layer disposed on the anode substrate; and a separator interposed between the cathode and the anode.

In yet another aspect is provided a process for preparing a lithium-ion battery anode slurry, the process comprising:
providing an anode material, a binder, a conductive material, and a solvent; and
combining the anode material, the binder, and the conductive material in the solvent, wherein the slurry is a homogenous dispersion having a viscosity in a range from about 500 mPa·s to about 3500 mPa·s, and wherein a solids content of the slurry is in a range from about 30 to 60% by weight, based on the total weight of the slurry.

In some aspects, the viscosity of the slurry is in a range from about 1300 to about 1700 mPa·s at a shear rate of about 167/s.

In some aspects, combining comprises:
i) dissolving the binder in a portion of the solvent to form a binder solution;
ii) adding the conductive material to the binder solution to form a suspension;
iii) mixing the suspension for a period of time;
iv) adding the carbon-silicon composite;
v) adding at least a portion of the solvent; and
vi) mixing the slurry until a homogenous dispersion is obtained.

In some aspects, the binder is polyacrylic acid.

In some aspects, the process further comprises providing graphite and a rheology modifier, and combining the graphite and the rheology modifier with the anode material, the binder, and the conductive material in the solvent.

In some aspects, combining comprises:
i) dissolving the rheology modifier in a portion of the solvent to form a rheology modifier solution;
ii) adding the conductive material to the rheology modifier solution to form a suspension;
iii) mixing the suspension for a period of time;
iv) adding the carbon-silicon composite to the suspension;
v) mixing the suspension for a period of time;
vi) adding at least a portion of the solvent;
vii) adding the graphite to the suspension;
viii) adding at least a portion of the solvent;
vix) adding the binder to form the slurry; and
vx) mixing the slurry until a homogenous dispersion is obtained.

In some aspects, the binder is styrene-butadiene rubber.

In some aspects, the rheology modifier is carboxymethylcellulose.

In a yet further aspect is provided a process for preparing a lithium-ion battery anode, the process comprising: coating a slurry as described herein on a substrate to form a coated substrate; and drying the coated substrate.

In some aspects, the process further comprises calendaring to achieve a density of at least about 1.5 g/cm³.

The disclosure includes, without limitations, the following aspects.

Aspect 1: A slurry for preparation of a lithium-ion battery anode, the slurry having a viscosity in a range from about 500 mPa·s to about 3500 mPa·s, the slurry comprising:
75-90% by weight of an anode active material comprising a carbon-silicon composite having a surface area in a range from about 3 to about 75 m²/g;
5-15% by weight of a binder material;
1-10% by weight of a conductive material; and
a solvent;
wherein all percent by weight values are on a dry weight basis and are based on the total weight of the slurry after removal of the solvent.

Aspect 2: The slurry of aspect 1, wherein the carbon-silicon composite has a surface area in a range from about 1 m²/g to about 400 m²/g.

Aspect 3: The slurry of aspect 1 or 2, wherein the carbon-silicon composite has a tap density in a range from about 0.3 g/cm³ to about 1.3 g/cm³.

Aspect 4: The slurry of any one of aspects 1-3, wherein the carbon-silicon composite comprises silicon in an amount by weight greater than about 10%, based on the total weight of the carbon-silicon composite.

Aspect 5: The slurry any one of aspects 1-4, wherein the carbon-silicon composite comprises silicon in a range from about 20% by weight to about 85% by weight, based on the total weight of the carbon-silicon composite.

Aspect 6: The slurry of any one of aspects 1-5, wherein the carbon-silicon composite comprises silicon in a range from about 20 to about 55%, or from about 30% by weight to about 35% by weight, based on the total weight of the carbon-silicon composite.

Aspect 7: The slurry of any one of aspects 1-6, wherein the carbon-silicon composite is an aerogel, a xerogel, a cryogel, or an ambigel.

Aspect 8: The slurry of any one of aspects 1-7, wherein the carbon-silicon composite comprises a carbonized polyimide aerogel.

Aspect 9: The slurry of any one of aspects 1-8, wherein the carbon-silicon composite comprises a pore structure, the pore structure comprising a fibrillar morphology and an array of pores surrounding elemental silicon.

Aspect 10: The slurry of any one of aspects 1-9, wherein the silicon in the carbon-silicon composite is present in particulate form, the particles having an average particle size of about 1 μm or less.

Aspect 11: The slurry of any one of aspects 1-10, wherein the carbon-silicon composite has a specific capacity of at least 400 mAh/g, or at least 1000 mAh/g.

Aspect 12: The slurry of any one of aspects 1-11, wherein the anode active material has a particle size D90 value of less than or equal to 40 μm.

Aspect 13: The slurry of any one of aspects 1-12, wherein the anode active material has a particle size D50 in a range from about 5 μm to about 20 μm.

Aspect 14: The slurry of c any one of aspects 1-13, wherein the anode active material has a particle size D10 value of at least 1 μm.

Aspect 15: The slurry of any one of aspects 1-14, wherein a percentage of solids in the slurry is in a range from about 30% to about 35% by weight.

Aspect 16: The slurry of any one of aspects 1-15, wherein a percentage of solids in the slurry is in a range from about 35% to about 60% by weight.

Aspect 17: The slurry of any one of aspects 1-16, wherein a percentage of solids in the slurry is in a range from about 45% to about 50% by weight.

Aspect 18: The slurry of any one of aspects 1-17, wherein the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

Aspect 19: The slurry of any one of aspects 1-18, wherein the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, cyanoethylsucrose, fluorinated polymer, chlorinated polymer, a salt of alginic acid, polyvinylidene fluoride, poly(vinylidene fluoride)-hexafluoropropene, and combinations thereof.

Aspect 20: The slurry of any one of aspects 1-19, wherein the binder material is selected from the group consisting of styrene-butadiene rubber, acrylated styrene-butadiene rubber, polyacrylonitrile, polyacrylic acid, lithiated polyacrylic acid, ammonia polyacrylic acid, polyvinylidene fluoride, and combinations thereof.

Aspect 21: The slurry of any one of aspects 1-20, wherein the binder material is polyacrylic acid.

Aspect 22: The slurry of any one of aspects 1-21, wherein the solvent is selected from the group consisting of N-methyl-2-pyrrolidone, dimethylformamide, dimethyl sulfoxide, acetonitrile, butylene carbonate, propylene carbonate, ethyl bromide, tetrahydrofuran, dimethyl carbonate, diethyl carbonate, ethyl methyl, carbonate methyl propyl carbonate, ethylene carbonate, water, ethanol, isopropanol, methanol, acetone, n-propanol, t-butanol, and combinations thereof.

Aspect 23: The slurry of any one of aspects 1-22, wherein the solvent is selected from the group consisting of N-methyl-2-pyrrolidone, dimethylformamide, water, and combinations thereof.

Aspect 24: The slurry of any one of aspects 1-23, wherein the solvent is water.

Aspect 25: The slurry of any one of aspects 1-24, wherein a pH value of the slurry is from about 6 to about 8.

Aspect 26: A lithium-ion battery anode slurry having a viscosity in a range from about 500 mPa·s to about 3500 mPa·s, the slurry comprising:
80-95% by weight of an anode active material comprising (i) a carbon-silicon composite having a surface area in a range from about 3 to about 75 m²/g, and (ii) a carbon active material;
2-15% by weight of a binder material;
0.5-10% by weight of a conductive material; and
a solvent;
wherein all percent by weight values are on a dry weight basis and are based on the total weight of the slurry.

Aspect 27: The slurry of aspect 26, wherein the graphite has a surface area of 3 to 5 m²/g and a particle size D50 value of about 12 μm.

Aspect 28: The slurry of aspect 26 or 27, wherein the anode active material comprises a ratio of about 80 wt % carbon active material to about 20 wt % carbon-silicon composite.

Aspect 29: The slurry of any one of aspects 26-28, wherein the carbon-silicon composite comprises silicon in an amount by weight greater than about 10%, based on the total weight of the carbon-silicon composite.

Aspect 30: The slurry of any one of aspects 26-29, wherein the carbon-silicon composite comprises silicon in a range from about 20 by weight to about 85% by weight, or from about 30% by weight to about 55% by weight, based on the total weight of the carbon-silicon composite.

Aspect 31: The slurry of any one of aspects 26-30, wherein the carbon-silicon composite comprises silicon in a range from about 30% by weight to about 35% by weight, based on the total weight of the carbon-silicon composite.

Aspect 32: The slurry of any one of aspects 26-31, wherein the silicon in the carbon-silicon composite is present in particulate form, the particles having an average particle size of about 1 μm or less.

Aspect 33: The slurry of any one of aspects 26-32, wherein the carbon-silicon composite is an aerogel, a xerogel, a cryogel, or an ambigel.

Aspect 34: The slurry of any one of aspects 26-33, wherein the carbon-silicon composite comprises a carbonized polyimide aerogel.

Aspect 35: The slurry of any one of aspects 26-34, wherein the carbon-silicon composite comprises a pore structure, the pore structure comprising a fibrillar morphology and an array of pores surrounding elemental silicon.

Aspect 36: The slurry of any one of aspects 26-35, wherein the carbon-silicon composite has a tap density in a range from about 0.3 g/cm³ to about 1.3 g/cm³.

Aspect 37: The slurry of any one of aspects 26-36, wherein the carbon-silicon composite has a specific capacity of at least 400 mAh/g.

Aspect 38: The slurry of any one of aspects 26-37, wherein the anode active material has a particle size D90 value of less than or equal to 40 μm.

Aspect 39: The slurry of any one of aspects 26-38, wherein the anode active material has a particle size D50 in a range from about 5 μm to about 20 μm.

Aspect 40: The slurry of any one of aspects 26-39, wherein the anode active material has a particle size D10 value of at least 1 μm.

Aspect 41: The slurry of any one of aspects 26-40, wherein a percentage of solids in the slurry is in a range from about 30% to about 35% by weight.

Aspect 42: The slurry of any one of aspects 26-41, wherein a percentage of solids in the slurry is in a range from about 35% to about 60% by weight.

Aspect 43: The slurry of any one of aspects 26-42, wherein a percentage of solids in the slurry is in a range from about 45% to about 50% by weight.

Aspect 44: The slurry of any one of aspects 26-43, wherein the carbon active material is selected from the group consisting of mesoporous carbon, natural graphite, synthetic graphite, graphite flakes, hard carbon, soft carbon, and combinations thereof.

Aspect 45: The slurry of any one of aspects 26-44, wherein the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

Aspect 46: The slurry of any one of aspects 26-45, wherein the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, fluorinated polymer, chlorinated polymer, a salt of alginic acid, polyvinylidene fluoride, poly(vinylidene fluoride)-hexafluoropropene, and combinations thereof.

Aspect 47: The slurry of any one of aspects 26-46, wherein the binder material is selected from the group consisting of styrene-butadiene rubber, acrylated styrene-butadiene rubber, polyacrylonitrile, polyacrylic acid, lithiated polyacrylic acid, ammonia polyacrylic acid, polyvinylidene fluoride, and combinations thereof.

Aspect 48: The slurry of any one of aspects 26-47, wherein the binder material is selected from the group consisting of polyacrylic acid, styrene-butadiene rubber, and combinations thereof.

Aspect 49: The slurry of any one of aspects 26-48, wherein the binder material is styrene-butadiene rubber, the slurry further comprising a rheology modifier.

Aspect 50: The slurry of any one of aspects 26-49, wherein the rheology modifier is carboxymethyl cellulose, hydroxypropyl cellulose, cellulose acetate, cellulose acetate butyrate, cellulose acetate propionate, cyanoethylcellulose, or a combination thereof.

Aspect 51: The slurry of any one of aspects 26-50, wherein the rheology modifier is carboxymethyl cellulose.

Aspect 52: The slurry of any one of aspects 26-51, wherein the solvent is selected from the group consisting of N-methyl-2-pyrrolidone, dimethylformamide, dimethyl sulfoxide, acetonitrile, butylene carbonate, propylene carbonate, ethyl bromide, tetrahydrofuran, dimethyl carbonate, diethyl carbonate, ethyl methyl, carbonate methyl propyl carbonate, ethylene carbonate, water, ethanol, isopropanol, methanol, acetone, n-propanol, t-butanol, and combinations thereof.

Aspect 53: The slurry of any one of aspects 26-52, wherein the solvent is selected from the group consisting of N-methyl-2-pyrrolidone, dimethylformamide, water, and combinations thereof.

Aspect 54: The slurry of any one of aspects 26-53, wherein the solvent is water.

Aspect 55: The slurry of any one of aspects 26-54, wherein a pH value of the slurry is from about 6 to about 8.

Aspect 56: The slurry of any one of aspects 1-55, wherein the viscosity of the slurry is in a range from about 1300 to about 1700 mPa·s at a shear rate of about 167/s.

Aspect 57: An anode electrode composition comprising:
from about 75 to about 90% by weight of an anode active material comprising a carbon-silicon composite having a surface area in a range from about 3 to about 75 m²/g;
from about 2 to about 20% by weight of a binder material; and
from about 0.5 to about 15% by weight of a conductive material;
wherein all percent by weight values are on a dry weight basis and are based on the total weight of the composition.

Aspect 58: The anode electrode composition of aspect 57, wherein the anode active material further comprises graphite.

Aspect 59: The anode electrode composition of aspect 57 or 58, wherein the anode active material comprises a ratio of about 80 wt % carbon active material to about 20 wt % carbon-silicon composite.

Aspect 60: The anode electrode composition of any one of aspects 57-59, wherein the carbon-silicon composite comprises silicon in a range from about 20% by weight to about 85% by weight, based on the total weight of the carbon-silicon composite.

Aspect 61: The anode electrode composition of any one of aspects 57-60, wherein the silicon in the carbon-silicon composite is present in particulate form, the particles having an average particle size of about 1 μm or less.

Aspect 62: The anode electrode composition of any one of aspects 57-61, wherein the carbon-silicon composite is an aerogel, a xerogel, a cryogel, or an ambigel.

Aspect 63: The anode electrode composition of any one of aspects 57-62, wherein the carbon-silicon composite comprises a carbonized polyimide aerogel.

Aspect 64: The anode electrode composition of any one of aspects 57-63, wherein the carbon-silicon composite comprises a pore structure, the pore structure comprising a fibrillar morphology and an array of pores surrounding elemental silicon.

Aspect 65: The anode electrode composition of any one of aspects 57-64, wherein the carbon-silicon composite has a tap density in a range from about 0.3 g/cm³ to about 1.3 g/cm³.

Aspect 66: The anode electrode composition of any one of aspects 57-65, wherein the carbon-silicon composite has a specific capacity of at least 400 mAh/g.

Aspect 67: The anode electrode composition of any one of aspects 57-66, wherein the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

Aspect 68: The anode electrode composition of any one of aspects 57-67, wherein the binder material is styrene-butadiene rubber, the anode electrode composition further comprising a rheology modifier.

Aspect 69: The anode electrode composition of aspect 68, wherein the rheology modifier is carboxymethyl cellulose.

Aspect 70: An anode for a lithium-ion battery, the anode comprising:
an anode substrate; and
an anode electrode layer disposed on the anode substrate, wherein the anode electrode layer comprises the anode electrode composition of any one of aspects 57 to 69.

Aspect 71: The anode of aspect 70, wherein the substrate is a copper film.

Aspect 72: The anode of aspect 70 or 71, wherein the anode electrode layer is loaded on the substrate at a density from 2.5 to about 4.5 mg/cm².

Aspect 73: The anode of any one of aspects 70-72, wherein the anode electrode layer is from about 10 μm to about 300 μm in thickness.

Aspect 74: The anode of any one of aspects 70-73, wherein the press density of the anode electrode layer is in a range from about 0.3 to about 2 g/cm³.

Aspect 75: The anode any one of aspects 70-74, wherein the areal capacity of the anode electrode layer is 4.5-5.5 mAh/cm².

Aspect 76: The anode any one of aspects 70-75, wherein the conductivity of the anode electrode layer is at least about 10 S/cm.

Aspect 77: A lithium-ion battery comprising:
a cathode;
the anode of any one of aspects 70 to 76; and
a separator interposed between the cathode and the anode.

Aspect 78: A process for preparing a lithium-ion battery anode slurry, the process comprising:
providing an anode material, a binder, a conductive material, and a solvent; and
combining the anode material, the binder, and the conductive material in the solvent, wherein the slurry is a homogenous dispersion having a viscosity in a range from about 500 mPa·s to about 3500 mPa·s, and wherein a solids content of the slurry is in a range from about 30 to 60% by weight, based on the total weight of the slurry.

Aspect 79: The process of aspect 78, wherein combining comprises:
i) dissolving the binder in a portion of the solvent to form a binder solution;
ii) adding the conductive material to the binder solution to form a suspension;
iii) mixing the suspension for a period of time;
iv) adding the carbon-silicon composite;
v) adding at least a portion of the solvent; and
vi) mixing the slurry until a homogenous dispersion is obtained.

Aspect 80: The process of aspect 77 or 78, wherein the binder is polyacrylic acid.

Aspect 81: The process of any one of aspects 77-79, further comprising providing graphite and a rheology modifier, and combining the graphite and the rheology modifier with the anode material, the binder, and the conductive material in the solvent.

Aspect 82: The process of aspect 81, wherein combining comprises:
i) dissolving the rheology modifier in a portion of the solvent to form a rheology modifier solution;
ii) adding the conductive material to the rheology modifier solution to form a suspension;
iii) mixing the suspension for a period of time;
iv) adding the carbon-silicon composite to the suspension;
v) mixing the suspension for a period of time;
vi) adding at least a portion of the solvent;
vii) adding the graphite to the suspension;
viii) adding at least a portion of the solvent;
vix) adding the binder to form the slurry; and
vx) mixing the slurry until a homogenous dispersion is obtained.

Aspect 83: The process of aspect 82, wherein the binder is styrene-butadiene rubber.

Aspect 84: The process of aspect 82 or 83, wherein the rheology modifier is carboxymethylcellulose.

Aspect 85: The process of any one of aspects 78-84, wherein the viscosity of the slurry is in a range from about 1300 to about 1700 mPa·s at a shear rate of about 167/s.

Aspect 86: A process for preparing a lithium-ion battery anode, the process comprising: coating the slurry of any one of aspects 1-56 on a substrate to form a coated substrate; and drying the coated substrate.

Aspect 87: The process of aspect 86, further comprising calendaring to achieve a density of at least about 1.5 g/cm³.

These and other features, aspects, and advantages of the disclosure will be apparent from a reading of the following detailed description. The invention includes any combination of two, three, four, or more of the above-noted aspects as well as combinations of any two, three, four, or more features or elements set forth in this disclosure, regardless of whether such features or elements are expressly combined in a specific aspect description herein. This disclosure is intended to be read holistically such that any separable features or elements of the disclosed invention, in any of its various aspects, should be viewed as intended to be combinable unless the context clearly dictates otherwise.

### DETAILED DESCRIPTION

Before describing several example aspects of the technology, it is to be understood that the technology is not limited to the details of construction or process steps set forth in the following description. The technology is capable of other aspects and of being practiced or being carried out in various ways.

In general, the technology is directed to lithium-ion battery anode slurries, lithium-ion battery anodes, and methods of preparation of each thereof, as well as batteries comprising such anodes. Each of the materials and methods are described further herein below.

### Definitions

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article.

The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the term “aerogel” or “aerogel material” refers to a gel comprising a framework of interconnected structures, with a corresponding network of interconnected pores integrated within the framework, and containing gases such as air as a dispersed interstitial medium; and which is characterized by the following physical and structural properties (according to nitrogen porosimetry testing) attributable to aerogels: (a) an average pore diameter ranging from about 2 nm to about 100 nm; (b) a porosity of at least 80% or more, and (c) a surface area of about 20 m²/g or more, such as 20-100 m²/g, or even greater than 100 m²/g, as measured by nitrogen sorption analysis. It can be understood that the inclusion of additives, such as a reinforcement material or an electrochemically active species, may decrease porosity of the resulting aerogel composite. Densification may also decrease porosity of the resulting aerogel composite.

Within the context of the present disclosure, the term “surface area” refers to the total volume occupied by a given weight of a material. The terms “surface area” and “specific surface area” are used synonymously with “BET surface area” which herein has its usual meaning of referring to the Brunauer, Emmett, Teller method for determining surface area by N2 adsorption.

Aerogel materials of the present disclosure thus include any aerogels or other open-celled compounds, which satisfy the defining elements set forth in previous paragraphs, including compounds, which can be otherwise categorized as xerogels, cryogels, ambigels, microporous materials, and the like.

As used herein, the terms “xerogel” and “ambigel” refer to gels comprising an open, non-fluid colloidal or polymer network that is formed by the removal of all swelling agents from a corresponding wet gel without any precautions taken to avoid substantial volume reduction or compaction, such as under ambient pressure drying. In contrast to an aerogel, a xerogel, such as a carbon xerogel, generally comprises a compact structure. Xerogels suffer substantial volume reduction during ambient pressure drying, and can have lower surface areas compared to aerogels, such as from about 0 to about 100 m²/g, or from about 0 to about 20 m²/g, as measured by nitrogen sorption analysis.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 Angstroms. However, framework structures of the present disclosure can also include networks of interconnected oligomers, polymers, or colloidal particles of all diameter sizes that form the solid structure within a gel or aerogel.

Within the context of the present disclosure, the term “fibrillar morphology” refers to the structural morphology of a nanoporous carbon (e.g., aerogel) being inclusive of struts, rods, fibers, or filaments. It should be noted that this fibrillar morphology can be found in nanoporous carbons of both a monolithic form and a powder form; in other words, a monolithic carbon can have a fibrillar morphology, and aerogel powder/particles can have a fibrillar morphology.

Aerogels and xerogels can be formed of inorganic materials, organic materials, or mixtures thereof. When formed of organic materials such as, for example, phenols, resorcinol-formaldehyde (RF), phloroglucinol-furfuraldehyde (PF), polyacrylonitrile (PAN), polyimide (PI), polyurethane (PU), polyurea (PUA), polyamine (PA), polybutadiene, polydicyclopentadiene, and precursors or polymeric derivatives thereof, the organic aerogel may be carbonized (e.g., by pyrolysis) to form a carbon aerogel, which can have properties (e.g., pore volume, pore size distribution, morphology, etc.) that differ or overlap from each other, depending on the precursor materials and methodologies used.

The terms “carbon aerogel” and “carbon xerogel” as used herein refers to porous or highly porous, carbon-based materials. Some non-limiting examples of carbon aerogels and xerogels include carbonized xerogels and aerogels such as carbonized polyimide aerogel and xerogels. The term “carbonized” in the context of aerogels and xerogels refers to an organic gel (e.g., a polyimide) which has been subjected to pyrolysis in order to decompose or transform the organic aerogel or xerogel composition to at least substantially pure carbon. As used herein, the term “pyrolyze” or “pyrolysis” or “carbonization” refers to the decomposition or transformation of an organic compound or composition to pure or substantially pure carbon caused by heat.

As used herein, the term “electrode” refers to a “cathode” or an “anode.” As used herein, the term “positive electrode” is used interchangeably with cathode. Likewise, the term “negative electrode” is used interchangeably with anode.

Within the context of the present disclosure, the term “capacity” refers to the amount of specific energy or charge that a battery is able to store. Capacity is specifically measured as the discharge current that the battery can deliver over time, per unit mass. It is typically recorded as Ampere-hours or milliAmpere-hours per gram of total electrode mass, Ah/g or mAh/g. For example, a battery with 1 Ah capacity can supply a current of one ampere for one hour or 0.5 amps for two hours, etc. Therefore, 1 Ampere-hour (Ah) is the equivalent of 3,600 coulombs of electrical charge. Similarly, the term “milliampere-hour (mAh)” also refers to a unit of the storage capacity of a battery and is 1/1,000 of an Ampere-hour. The capacity of a battery (and an anode in particular) may be determined by methods known in the art, for example including, but not limited to: applying a fixed constant current load to a fully charged cell until the cell's voltage reaches the end of discharge voltage value; the time to reach end of discharge voltage multiplied by the constant current is the discharge capacity; by dividing the discharge capacity by the weight of electrode material or volume. Within the context of the present disclosure, measurements of capacity are acquired according to this method, unless otherwise stated. Unless otherwise noted, capacity is reported at cycle 10 of the battery.

As used herein, the term “battery cycle life” refers to the number of complete charge/discharge cycles a battery can perform before its nominal capacity falls below 80% of its initial rated capacity. Cycle life may be affected by a variety of factors that are not significantly impacted over time, for example mechanical strength of the underlying substrate (e.g., carbon aerogel), connectivity of the silicon particles within the aerogel, and maintenance of interconnectivity of the aerogel. It is noted that these factors actually remaining relatively unchanged over time is a surprising aspect of certain aspects of the current invention. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. In certain aspects of the present disclosure, energy storage devices, such as batteries, or electrode thereof, have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

As used herein, the term “particle size D50” refers to a volume-based accumulative 50% size which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%. Further, with respect to the anode material of the present disclosure, the particle size D50 means a volume-averaged particle size of secondary particles which are formed by mutual agglomeration and sintering of primary particles, and in a case where the particles are composed of the primary particles only, it means a volume-averaged particle size of the primary particles. Furthermore, D10 means a volume-based accumulative 10% size (i.e., a diameter of a particle in the 10th percentile of the volumes of particles), and D90 means a volume-based accumulative 90% size (i.e., a diameter of a particle in the 90th percentile of the volumes of particles).

Within the context of the present disclosure, the term “density” refers to a measurement of the mass per unit volume of a material (e.g., a carbon-silicon composite material as described herein). The term “density” generally refers to the true or skeletal density of a material, the bulk density of a material or composition, or the tap density of a material or composition. Density is typically reported as kg/m3 or g/cm³.

The skeletal density of a material is the ratio of the mass of the material to the volume of the material excluding any pores in the material and any void spaces between particles of the material. Skeletal density of the carbon-silicon composite material may be determined by methods known in the art, including, but not limited to helium pycnometry.

The bulk density of a material is the ratio of the mass of the material to the volume of the material including any pores in the material and any void spaces between particles of the material. Also referred to as “envelope density,” the bulk density may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland). Within the context of the present disclosure, density measurements are acquired according to ASTM C167 standards, unless otherwise stated.

Within the context of the present disclosure, the term “tap density” or “tapped density” of a material is the ratio of the mass of the material to the volume of the material measured when the material is vibrated or tapped under specific conditions. The tapped density of a powder represents its random dense packing. Tapped density values are higher for more regularly shaped particles (e.g., spheres) as compared to irregularly shaped particles. Tapped density can be calculated using the formula M/Vf, where M=mass in grams, and Vf=the tapped volume in cubic centimeters (cm³). Tapped density is generally measured by first gently introducing a known sample mass into a graduated cylinder and carefully leveling the powder without compacting it. The cylinder is then mechanically tapped by raising the cylinder and allowing it to drop under its own weight using a suitable mechanical tapped density tester that provides a suitable fixed drop distance and nominal drop rate. Standard test methods for tap density measurements are described in MPIF-46, ASTM B-527, and ISO 3953.

### Anode Slurry

In one aspect of the disclosure is provided an anode slurry for preparation of a lithium-ion battery. The slurry comprises an anode active material comprising a carbon-silicon composite. The anode slurry also comprises one or more binder materials, one or more conductive materials, and a solvent. The anode slurry may further comprise a rheology modifier. Each of the slurry components is described further herein below.

### Anode Active Material

### Carbon-Silicon Composite

The anode slurry as disclosed herein comprises a carbon-silicon composite comprising a low bulk density carbon material. In some aspects, the low bulk density carbon material comprises a skeletal framework comprising carbon nanofibers, the skeletal framework forming a pore structure comprising an array of interconnected pores surrounding elemental silicon. Such materials may be described as possessing a fibrillar morphology. Examples of suitable low bulk density carbon materials, carbon-silicon composites, and processes for the manufacture of such materials and composites are described in, for example, U.S. Patent Application Publication Nos. 2020/0269207 and 2022/006929, both to Zafiropoulos et al.; and U.S. Patent Application Publication Nos. 2022/0185985 to Begag et al., 2022/0278333 to Zafiropoulos et al., 2022/0185970 to Leventis et al., and 2022/0209234 to Trifu et al., each of which is incorporated by reference herein with respect to such materials, composites, and processes.

In some aspects, the carbon-silicon composite is an aerogel, a xerogel, a cryogel, or an ambigel. In some aspects, the carbon-silicon composite is an aerogel. In some aspects, the carbon-silicon aerogel is obtained from the carbonization of a suitable organic aerogel. In an exemplary aspect, the carbon aerogel is formed from a pyrolyzed/carbonized polyimide-based aerogel, i.e., the polymerization of polyimide. Even more specifically, the polyimide-based aerogel can be produced using one or more methodologies described in U.S. Pat. Nos. 7,071,287 and 7,074,880 to Rhine et al., e.g., by imidization of poly(amic) acid and drying the resulting gel using a supercritical fluid. Other adequate methods of producing polyimide aerogels (and carbon aerogels derived therefrom) are contemplated herein as well, for example as described in U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261; Leventis et al., Isocyanate-Derived Organic Aerogels: Polyureas, Polyimides, Polyamides, MRS Proceedings, 1306 (2011), Mrsf10-1306-bb03-01. doi: 10.1557/opl.2011.90; Chidambareswarapattar et al., One-step room-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low-Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383. The resulting polyimide aerogel would then be pyrolyzed to form a polyimide-derived carbon aerogel.

Silicon may be introduced into the composite in various manners. For example, silicon can be introduced as elemental silicon, or may be introduced in the form of a silicon-containing reagent which is subsequently reduced to silicon. The silicon or silicon precursor may be introduced into the low bulk density carbon material or may be introduced into a precursor of the low bulk density carbon material, such as during or after gelation of an organic (e.g., polyimide) gel prior to carbonization.

Generally, the silicon is contained at least partially within the pores of the low bulk density carbon material, i.e., the silicon is disposed within the framework of the low-density carbon material. As an anode material, the silicon accepts lithium ions during charge and releases lithium ions during discharge. In certain aspects, the nanoporous carbon network forms interconnected structures around the silicon, which is connected to the nanoporous carbon at a plurality of points.

The silicon is generally present in the carbon-silicon composite as silicon particles. Within the context of the present disclosure, the term “silicon particles” refers to silicon or silicon-based materials with a range of particle sizes. The particle size of the silicon in the carbon-silicon composite may vary. Silicon particles of the present disclosure can be nanoparticles, e.g., particles with two or three dimensions in the range of about 1 nm to about 150 nm. Silicon particles of the present disclosure can be fine particles, e.g., micron-sized particles with a maximum dimension, e.g., a diameter for a substantially spherical particle, in the range of about 150 nm to about 10 micrometers or larger. For example, silicon particles of the present disclosure can have a maximum dimension, e.g., a diameter for a substantially spherical particle, of about 10 nm, 50 nm, 100 nm, 150 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values.

In some aspects, the silicon particles can be monodispersed or substantially monodispersed. In other aspects, the silicon particles can have a particle size distribution. Within the context of the present disclosure, the dimensions of silicon particles are provided based upon the median of the particle size distribution, i.e., the D50. In some aspects, the silicon in the carbon-silicon composite has an average particle size of about 1 μm or less.

Silicon particles of the present disclosure can be silicon wires, crystalline silicon, amorphous silicon, silicon alloys, silicon oxides (SiOx), coated silicon, e.g., carbon coated silicon, and any combinations thereof. In some aspects, silicon particles can be substantially planar flakes, i.e., having a flat fragmented shape, which can also be referred to as a platelet shape. For example, the particles have two substantially flat major surfaces connected by a minor surface defining the thickness between the major surfaces. In some aspects, the particles are flat fragmented shapes, e.g., platelets, having two dimensions, e.g., a length and a width, of about 10 nm, 50 nm, 100 nm, 150 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values. In other aspects, particles of silicon can be substantially spherical, cubic, obloid, elliptical, disk-shaped, or toroidal.

The amount of silicon present in the carbon-silicon composite varies according to the density of the low bulk density carbon material, with lower densities resulting in higher weight percent incorporation of silicon. In some aspects, the carbon-silicon composite comprises silicon in an amount by weight from about 20 to about 85%, such as from about 20, about 25, about 30, about 35, about 40, about 45, or about 50, to about 55, about 60, about 65, about 70, about 75, about 80, or about 85% silicon by weight, based on the total weight of the carbon-silicon composite. In some aspects, the carbon-silicon composite comprises silicon in an amount by weight from about 30 to about 35% by weight, based on the total weight of the carbon-silicon composite.

The carbon-silicon composite may be in a variety of different physical forms. In some aspects, the carbon-silicon composite can take the form of a monolith. As used herein, the term “monolith” refers to materials in which a majority (by weight) of the low-density skeletal framework included in the carbon-silicon composite is in the form of a unitary, continuous, self-supporting object. With reference to aerogel materials, monolithic aerogel materials include aerogel materials which are initially formed to have a well-defined shape, but which can be subsequently cracked, fractured or segmented into non-self-repeating objects. For example, irregular chunks may be considered as monoliths. Monolithic aerogels may take the form of a freestanding structure, or a reinforced material with fibers or an interpenetrating foam.

In other aspects, the carbon-silicon composite may be in particulate form, for example as beads or as particles from, e.g., crushing a monolithic material. As used herein, the term “beads” is meant to include discrete small units or pieces having a generally spherical shape. In some aspects, the carbon-silicon composite beads are substantially spherical.

The carbon-silicon composite in particulate form can have various particle sizes. In the case of spherical particles (e.g., beads), the particle size is the diameter of the particle. In the case of irregular particles, the term particle size refers to the maximum dimension (e.g., a length, width, or height). The particle size may vary depending on the physical form, preparation method, and any subsequent physical steps performed. In some aspects, the carbon-silicon composite in particulate form can have a particle size from about 1 micrometer to about 1 millimeter. For example, the carbon-silicon composite in particulate form can have a particle size of about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, about 60 micrometers, about 70 micrometers, about 80 micrometers, about 90 micrometers, about 100 micrometers, about 200 micrometers, about 300 micrometers, about 400 micrometers, about 500 micrometers, about 600 micrometers, about 700 micrometers, about 800 micrometers, about 900 micrometers, about 1 millimeter, or in a range between any two of these values.

In some aspects, the carbon-silicon composite has a particle size D90 value of less than or equal to 40 micrometers. In some aspects, the carbon-silicon composite has a particle size D10 value of at least 1 micrometer. In some aspects, the carbon-silicon composite has a particle size D50 in a range from about 5 micrometers to about 20 micrometers.

The density of the carbon-silicon composite may vary. In some aspects, the carbon-silicon composite has a tap density in a range from about 0.15 g/cm³ to about 1.2 g/cm³.

The surface area of the carbon-silicon composite may vary. For example, the surface area may be up to about 100 m²/g, or may be greater than 100 m²/g. In some aspects, the carbon-silicon composite has a surface area in a range from about 1 m²/g to about 400 m²/g, such as from about 1, about 10, or about 50, to about 100, about 200, about 300, or about 400 m²/g. In some aspects, the carbon-silicon composite has a surface area in a range of about 10 m²/g to about 100 m²/g. In some aspects, the carbon-silicon composite has a surface area in a range of about 10 m²/g to about 50 m²/g. In some aspects, the carbon-silicon composite has a surface area in a range of about 10 m²/g to about 40 m²/g. In some aspects, the carbon-silicon composite has a surface area in a range of about 10 m²/g to about 30 m²/g. In some aspects, the carbon-silicon composite has a surface area in a range of about 10 m²/g to about 20 m²/g. For example, the carbon-silicon composite has a surface area of about 10 m²/g, about 20 m²/g, about 30 m²/g, about 40 m²/g, or about 50 m²/g. For another example, the carbon-silicon composite has a surface area of about 13 m²/g.

The compressive strength of the carbon-silicon composite may vary. Within the context of the present disclosure, the terms “compressive strength”, “flexural strength”, and “tensile strength” refer to the resistance of a material to breaking or fracture under compression forces, flexure or bending forces, and tension or pulling forces, respectively. These strengths are specifically measured as the amount of load/force per unit area resisting the load/force. It is typically recorded as pounds per square inch (psi), megapascals (MPa), or gigapascals (GPa). Among other factors, the compressive strength, flexural strength, and tensile strength of a material collectively contribute to the material's structural integrity, which is beneficial, for example, to withstand volumetric expansion of silicon particles during lithiation in a LIB. Referring specifically to Young's modulus, which is an indication of mechanical strength, the modulus may be determined by methods known in the art, for example including, but not limited to: Standard Test Practice for Instrumented Indentation Testing (ASTM E2546, ASTM International, West Conshocken, PA); or Standardized Nanoindentation (ISO 14577, International Organization for Standardization, Switzerland). Within the context of the present disclosure, measurements of Young's modulus are acquired according to ASTM E2546 and ISO 14577, unless otherwise stated. In certain aspects, carbon-silicon composites of the present disclosure have a Young's modulus of about 0.2 GPa or more, 0.4 GPa or more, 0.6 GPa or more, 1 GPa or more, 2 GPa or more, 4 GPa or more, 6 GPa or more, 8 GPa or more, or in a range between any two of these values.

The capacity of the carbon-silicon composite may vary. In some aspects, the carbon-silicon composite has a specific capacity of at least about 400 mAh/g. In some aspects, the carbon-silicon composite has a specific capacity of about 400, about 500, about 600, about 700, about 800, about 900, about 1000, or about 1100 mAh/g. In some aspects, the carbon-silicon composite has a specific capacity of 1200 mAh/g or more, 1400 mAh/g or more, 1600 mAh/g or more, 1800 mAh/g or more, 2000 mAh/g or more, 2400 mAh/g or more, 2800 mAh/g or more, 3200 mAh/g or more, or in a range between any two of these values.

In some aspects, the anode material further comprises graphite, such as synthetic graphite, natural graphite, hard carbon, or soft carbon. In some aspects, the graphite has a surface area of 1 to 10 m²/g. In some aspects, the graphite has a particle size D50 value of about 12 micrometers. In some aspects, the graphite has a surface area of 3 to 5 m²/g and a particle size D50 value of about 12 micrometers.

The electrical conductivity of the anode material may vary. Within the context of the present disclosure, the term “electrical conductivity” refers to a measurement of the ability of a material to conduct an electric current or other allow the flow of electrons therethrough or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84-resistivity (R) measurements obtained by measuring voltage (V) divided by current (I), unless otherwise stated. In certain aspects, anode materials of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

The amount of anode active material present in the slurry may vary depending on the desired slurry properties (e.g., density, viscosity, and the like). In some aspects, the slurry comprises an amount by weight of the anode active material, on a dry weight basis, from about 70 to about 95%, such as from about 70, about 75, or about 80, to about 85, about 90, or about 95%. In some aspects, the slurry comprises an amount by weight of the anode active material, on a dry weight basis, from about 80 to about 95%. In some aspects, the slurry comprises an amount by weight of the anode material, on a dry weight basis, of about 75 to about 90%.

In certain aspects, the slurry comprises an amount by weight of the anode active material, on a dry weight basis, of about 75 to about 90%, wherein the anode material comprises a carbon-silicon composite as described herein.

In other certain aspects, the slurry comprises an amount by weight of the anode active material, on a dry weight basis, of about 80 to about 95%, wherein the anode active material comprises a carbon-silicon composite as described herein, and further comprises a carbon active material, such as mesoporous graphite, synthetic graphite, natural graphite, graphite flakes, hard carbon, soft carbon, or a combination thereof. In such aspects, the relative amounts of carbon-silicon composite and carbon active material may vary. For example, the anode active material may comprise the carbon-silicon composite in an amount from about 1 to about 20%, such as from about 1, about 2, about 3, about 4, about 5, about 6, about 7, about 8, about 9 or about 10, to about 11, about 12, about 13, about 14, about 15, about 16, about 17, about 18, about 19, or about 20% by weight, based on the total weight of the anode active material, with the remainder of the anode material (e.g., up to about 99%, or up to about 80%) by weight being another carbon active material, such as graphite.

### Binder Material

The anode slurry comprises a binder material. As used herein, the term “binder material” refers to a chemical or a substance that provides one or both of cohesion and adhesion. As used herein, cohesion refers to the function of a binder to hold together the components in the electrode composition. As used herein, adhesion refers to the function of the binder to hold the components in the electrode composition in place on a current collector, e.g., in a LIB anode. Suitable binder materials generally include polymeric materials. In some aspects, binder materials can include rheology modifiers such as those discussed below.

In some aspects, the binder material is styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, fluorinated polymer, chlorinated polymer, a salt of alginic acid, polyvinylidene fluoride, poly(vinylidene fluoride)-hexafluoropropene, or a combination thereof. In some aspects, the binder material is selected from the group consisting of styrene-butadiene rubber, acrylated styrene-butadiene rubber, polyacrylonitrile, polyacrylic acid, lithiated polyacrylic acid, ammonia polyacrylic acid, polyvinylidene fluoride, and combinations thereof. In some aspects, the binder material is polyacrylic acid. In some aspects, the binder material is styrene-butadiene rubber. In some aspects, the binder material is a mixture of polyacrylic acid and styrene-butadiene rubber.

The molecular weight of the binder material may vary. For example, in some aspects, the binder material is polyacrylic acid having an average molecular weight in a range from about 50,000 to about 1,250,000 daltons, or from about 100,000 to about 450,000 daltons.

The amount of binder material present in the anode slurry may vary. In some aspects, the amount of binder material in the anode slurry is in a range from about 1% to about 20% by weight on a dry weight basis, based on the total weight of the slurry, such as from about 1, about 2, about 3, about 4, about 5, about 6, about 7, about 8, about 9, or about 10, to about 11, about 12, about 13, about 14, about 15, about 16, about 17, about 18, about 19, or about 20% by weight on a dry weight basis, based on the total weight of the slurry. In some aspects, the amount of binder material in the anode slurry is in a range from about 2 to about 15%, or from about 5 to about 15% by weight on a dry weight basis, based on the total weight of the slurry. In aspects comprising more than one binder material, it is to be understood that the amount of binder by weight reflects the total combined weight of the binder materials.

### Rheology Modifier

In some aspects, the anode slurry comprises a rheology modifier. As used herein, the term “rheology modifier” refers to a chemical or a substance that can be used to modify one or more properties of a slurry, such as thickness, viscosity, flowability, pourability, and dispersability, as well as leveling, adhesion, and film thickness of films prepared from such slurries. Rheology modifiers may be particularly useful in combination with certain binders such as SBR. Suitable rheology modifiers include, but are not limited to, cellulose derivatives, for example, carboxymethyl cellulose, hydroxypropyl cellulose, cellulose acetate, cellulose acetate butyrate, cellulose acetate propionate, or cyanoethylcellulose. In some aspects, the rheology modifier is carboxymethyl cellulose.

The molecular weight of the rheology modifier may vary. For example, in some aspects, the rheology modifier is carboxymethyl cellulose having an average molecular weight in a range from about 50,000 to about 600,000 daltons.

The amount of rheology modifier present in the anode slurry may vary. In some aspects, the amount of rheology modifier in the anode slurry is in a range from about 1% to about 5% by weight on a dry weight basis, based on the total weight of the slurry, such as from about 1, about 2, or about 3, to about 4, or about 5% by weight on a dry weight basis, based on the total weight of the slurry. In some aspects, the amount of rheology modifier in the anode slurry is in a range from about 1 to about 4%, or from about 1 to about 3% by weight on a dry weight basis, based on the total weight of the slurry.

### Conductive Material

The anode slurry comprises a conductive material. The term “conductive material” as used herein refers to a chemical, substance, or polymeric material that increases the electrical conductivity of an electrode (e.g., an anode or cathode). In some aspects, the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof. In some aspects, the conductive material is carbon black.

The particle size of the conductive material may vary. In some aspects, the particle size of conductive material is less than about 40 micrometers, such as from about 1 nanometer to about 40 micrometers, or from about 1 nanometer to about 1 micrometer.

The amount of conductive material present in the anode slurry may vary. In some aspects, the anode slurry does not contain a conductive material. In some aspects, the amount of the conductive material is in a range from about 0.1 to about 20% by weight on a dry weight basis, based on the total weight of the slurry, such as from about 0.1, about 0.5. or about 1, to about 5, about 10, about 15, or about 20% by weight on a dry weight basis, based on the total weight of the slurry. In some aspects, the anode slurry comprises from about 0.5 to about 15%, or from about 1 to about 10% by weight of the conductive material on a dry weight basis, based on the total weight of the slurry.

### Solvent

The anode slurry comprises a solvent. The solvent used in the anode slurry can be any polar organic solvent, water, or a mixture thereof. In some aspects, the solvent is a polar organic solvent. The polar organic solvent can be any polar protic or polar aprotic organic solvent having a dielectric constant of greater than 15, greater than 20, greater than 25, greater than 30, greater than 35, greater than 40, or greater than 45. Non-limiting examples of polar protic organic solvents include alcohols such as benzyl alcohol, ethylene glycol, n-butanol, t-butanol, isopropanol, n-propanol, ethanol, and methanol. Non-limiting examples of polar aprotic organic solvents include ketones, esters, amides, ethers, sulfoxides, nitriles, and carbonates. Non-limiting examples of ketones include methyl propyl ketone, methyl isobutyl ketone, ethyl propyl ketone, diisobutyl ketone, acetophenone, acetone, and the like. Non-limiting examples of esters include ethyl acetate, butyl acetate, isobutyl acetate n-butyl propionate, and n-pentyl propionate. Non-limiting examples of ethers include tetrahydrofuran, methyl-t-butyl ether, and ethylene glycol monoethylether. Non-limiting examples of amides include dimethylformamide and N-methyl-2-pyrrolidone (NMP). Non-limiting examples of carbonates include dimethyl carbonate, diethyl carbonate, ethylene carbonate, propylene carbonate, butylene carbonate, ethyl methyl carbonate, methyl propyl carbonate, and the like. Other non-limiting examples of polar aprotic organic solvent include acetonitrile, propionitrile, and dimethyl sulfoxide.

In some aspects, the solvent comprises water. In some aspects, the solvent is water. Non-limiting examples of types of water include tap water, distilled water, de-ionized water, reverse osmosis purified water, or a combination thereof.

In some aspects, the solvent is selected from the group consisting of N-methyl-2-pyrrolidone, dimethylformamide, dimethyl sulfoxide, acetonitrile, butylene carbonate, propylene carbonate, ethyl bromide, tetrahydrofuran, dimethyl carbonate, diethyl carbonate, ethyl methyl, carbonate methyl propyl carbonate, ethylene carbonate, water, ethanol, isopropanol, methanol, acetone, n-propanol, t-butanol, and combinations thereof. In some aspects, the solvent is selected from the group consisting of N-methyl-2-pyrrolidone, dimethylformamide, water, and combinations thereof. In some aspects, the solvent is water.

The amount of solvent present in the slurry may vary based on, e.g., the target viscosity and solids content of the slurry. For example, in some aspects, the solvent is present in an amount from about 20% to about 80%, from about 20% to about 70%, from about 20% to about 60%, from about 20% to about 50%, from about 20% to about 40%, from about 30% to 50%, from about 30% to about 40%, from about 40% to about 70%, from about 40% to about 60%, from about 40% to about 50%, from about 50% to about 80%, from about 50% to about 70%, from about 50% to about 60%, from about 25% to about 60%, from about 25% to about 50%, from about 25% to about 45%, from about 45% to about 60%, from about 45% to about 55%, or from about 45% to about 50% by weight or volume, based on the total weight or volume of the slurry.

### Preparation of Lithium-Ion Battery Anode Slurries

As a non-limiting example description, an anode slurry as described herein is generally prepared by mixing an anode material, a binder, and a conductive material, each as described herein, in a solvent to achieve a uniform dispersion of each of the materials. In some aspects, a rheology modifier may be utilized. A rheology modifier may be utilized, for example, in combination with certain binders such as SBR. The order of addition, mixing times, specific components, and the concentrations thereof may vary based on the conductive material and/or anode material.

In some aspects, the conductive material is graphite, and the anode material is a silicon-carbon composite as described herein. In such aspects, the preparation generally comprises preparing a solution of rheology modifier in the solvent, adding the anode material, adding the conductive material (e.g., graphite), and adding the binder. In some aspects, the solvent is water.

In some aspects, a rheology modifier is carboxymethyl cellulose. In some aspects, the carboxymethyl cellulose is dissolved in water to form a solution having a solids content from about 1 to about 4% by weight. In some aspects, the rheology modifier is a 1.5% by weight aqueous solution of carboxymethyl cellulose. The method of preparing the rheology modifier solution may vary based on the particular rheology modifier and batch size. For example, in large batches, carboxymethyl cellulose and water may be mixed overnight using an overhead mixer. In small batches, carboxymethyl cellulose and water may be mixed, allowed to stand for a period of time, and mixed again before use. The mixing speed and time may vary. For example, the mixing speed may be from about 1000 to about 3000 rpm, such as about 2000 or about 2500 rpm. The mixing time may be about 5 minutes or about 15 minutes, or about 1 hour, about 12 hours, or about 24 hours.

At least a portion of the carbon-silicon composite is then added, along with at least a portion of the total volume of water to be used in the final slurry. In some aspects, a portion of the total quantity of carbon-silicon composite is added followed by stirring, then the remainder of the carbon-silicon composite is added. In some aspects, the portion initially added is up to about 50% of the total quantity. The total volume of water is based on the BET surface area of the slurry components and the desired solids content (generally 30 to 60% solids content by weight, based on the total weight of the slurry). Slurry components with a high surface area require more water to provide the desired rheological properties of the slurry. In some aspects, the carbon-silicon composite is present in the slurry in a range from about 10 to about 15% by weight.

The conductive material (e.g., graphite is generally added to the rheology modifier solution, followed by mixing. The mixing speed and time may vary. For example, the mixing speed may be from about 1000 to about 3000 rpm, such as about 2000 or about 2500 rpm. The mixing is continued until a homogenous slurry is obtained. In some aspects, the mixing time may be from about 5 minutes to about 30 minutes. In some aspects, graphite is added following the carbon-silicon composite. In other aspects, graphite is added concurrently with the carbon-silicon composite. In other aspects, the carbon-silicon composite is added following the graphite.

Additional water is added as necessary to provide the required viscosity as described herein below, followed by further mixing of the slurry. The mixing speed and time may vary. For example, the mixing speed may be from about 1000 to about 3000 rpm, such as about 2000 or about 2500 rpm. The mixing is continued until a homogenous slurry is obtained. In some aspects, the mixing time may be from about 5 minutes to about 30 minutes.

The binder is then added. In some aspects, the binder is styrene-butadiene rubber (SBR). In some aspects, the SBR is provided as an emulsion having a solids content of less than about 100% by weight, such as about 40% by weight. Additional water is added as necessary to provide the required viscosity, followed by further mixing of the slurry. The mixing speed and time may vary. For example, the mixing speed may be from about 1000 to about 3000 rpm, such as about 1500 or about 2000 rpm. The mixing is continued until a homogenous slurry is obtained. In some aspects, the mixing time may be from about 30 seconds to about 30 minutes, such as about 1 minute. The speed and time are adjusted to prevent a rise in temperature from frictional forces.

In some aspects, the conductive material is carbon (e.g., carbon black), and the anode material is a silicon-carbon composite as described herein. In such aspects, the preparation generally comprises preparing a solution of binder in the solvent, adding the conductive material (e.g., carbon), and adding the anode material. Generally, a solution of binder is prepared in the desired solvent. In some aspects, the binder material is polyacrylic acid. In some aspects, the solvent is water. In some aspects, the resulting binder solution has a solids content in a range from about 5 to about 15% by weight. In some aspects, the binder material is polyacrylic acid, and the solution has a solids content of 10% by weight.

The conductive material (e.g., carbon) is generally added to the binder solution followed by mixing. The mixing speed and time may vary. For example, the mixing speed may be from about 1000 to about 3000 rpm, such as about 2000 or about 2500 rpm. The mixing is continued until a homogenous slurry is obtained. In some aspects, the mixing time may be from about 5 minutes to about 30 minutes.

At least a portion of the carbon-silicon composite is then added, along with at least a portion of the total volume of water to be used in the final slurry. In some aspects, a portion of the total quantity of carbon-silicon composite is added followed by stirring, then the remainder of the carbon-silicon composite is added. In some aspects, the portion initially added is up to about 50% of the total quantity. The total volume of water is based on the BET surface area of the slurry components and the desired solids content (generally 60 to 90% solids content by weight, based on the total weight of the slurry). Slurry components with a high surface area require more water to provide the desired rheological properties of the slurry. In some aspects, the carbon-silicon composite is present in the slurry in a range from about 10 to about 15% by weight. Additional water is added as necessary to provide the required viscosity, followed by further mixing of the slurry. The mixing speed and time may vary. For example, the mixing speed may be from about 1000 to about 3000 rpm, such as about 2000 or about 2500 rpm. The mixing is continued until a homogenous slurry is obtained. In some aspects, the mixing time may be from about 5 minutes to about 30 minutes.

By either general method, the physical properties of the resulting anode slurry may vary based on the particular components therein and the intended use. For example, the anode slurry may exhibit various pH values, solids contents, viscosities, and the like.

The pH of the anode slurry may vary. In some aspects, the pH of the anode slurry is from about 5 to about 10, such as from about 5 to about 9.5, from about 5.5 to about 9, from about 5.5 to about 8.5, from about 6 to about 8, from about 6 to about 7.5, or from about 6 to about 7.

The anode slurry may exhibit various solids contents. The term “solids content” as used herein refers to the amount of non-volatile material remaining after evaporation of solvent, and is used synonymously with “percentage of solids.” In some aspects, the percentage of solids in the slurry is in a range from about 30 to about 60% by weight, based on the total weight of the slurry. For example, in some aspects, the percentage of solids in the slurry is in a range from about 35% to about 60% by weight, in a range from about 30% to about 35% by weight, or in a range from about 45% to about 50% by weight, based on the total weight of the slurry. In some aspects, the percentage of solids in the slurry is about 30, about 35, about 40, about 45, about 50, about 55, or about 60% by weight, based on the total weight of the slurry.

In some aspects, it is desirable for the anode slurry to be “workable” in order to facilitate material handling associated with battery manufacturing. For example, if an anode slurry is too fluid it can be compositionally unstable (i.e., homogeneity can be lost under exposure to certain forces, such as gravity (e.g., solids settling) or centrifugal forces). If an anode slurry is unstable, solid phase density differences or other attributes can give rise to separation and/or compositional gradients. Alternatively, if an anode slurry is too solid, the slurry may break up, crumble, and/or otherwise segregate into pieces, which can complicate processing and dimensional control. Formulating an anode slurry within a band of adequate workability can facilitate easier slurry-based battery manufacturing. Workability of an anode slurry can typically be quantified using rheological parameters (e.g., apparent viscosity (ηₐₚₚᵣ Pa-s), apparent shear rate (γₐₚₚᵣ s⁻¹), or effective viscosity at a given shear rate). Said another way, a constant rheological parameter value can define a region in which “workable” formulations can be selected. Specifically, the rheological behavior of an anode slurry can indicate processability under pressure driven flows, such as in a single or twin-screw extrusion and/or flow through a die. Rheological parameters can be measured using different types of rheometers, including strain or stress-controlled rotational, capillary, slit, extensional, and capillary. In a capillary rheometer, a suspension (e.g., an anode slurry) in a reservoir/barrel can flow through a capillary tube/die under pressure generated by a piston. The flow and deformation behavior of the suspension can be characterized through generating flow rate versus pressure drop data by using various capillary dies with different diameters, lengths and entrance angles.

The anode slurry may exhibit a range of viscosities. Viscosity is generally provided in units of millipascal second (mPa·s) or centipoise (cP; one cP is equal to 1 mPa·s). In some aspects, the anode slurry has a viscosity from about 500 mPa·s to about 6,000 mPa·s, such as from about 500 mPa·s to about 5,500 mPa·s, from about 500 mPa·s to about 5,000 mPa·s, from about 500 mPa·s to about 4,500 mPa·s, from about 500 mPa·s to about 4,000 mPa·s, from about 500 mPa·s to about 3,500 mPa·s, from about 500 mPa·s to about 3,000 mPa·s, from about 1,000 mPa·s to about 6,000 mPa·s, from about 1,000 mPa·s to about 5,500 mPa·s, from about 1,000 mPa·s to about 5,000 mPa·s, from about 1,000 mPa·s to about 4,500 mPa·s, from about 1,000 mPa·s to about 4,000 mPa·s, from about 1,000 mPa·s to about 3,500 mPa·s, from about 1,000 mPa·s to about 3,000 mPa·s, from about 1,000 mPa·s to about 2,500 mPa·s, from about 1,000 mPa·s to about 2,000 mPa·s, from about 1,500 mPa·s to about 4,000 mPa·s, from about 1,500 mPa·s to about 3,500 mPa·s, from about 1,500 mPa·s to about 3,000 mPa·s, from about 2,000 mPa·s to about 4,000 mPa·s, from about 2,000 mPa·s to about 3,500 mPa·s, or from about 2,000 mPa·s to about 3,000 mPa·s.

In some aspects, the anode slurry has a viscosity less than 6,000 mPa·s, less than 5,500 mPa·s, less than 5,000 mPa·s, less than 4,500 mPa·s, less than 4,000 mPa·s, less than 3,500 mPa·s, less than 3,000 mPa·s, less than 2,500 mPa·s, less than 2,000 mPa·s, or less than 1,000 mPa·s. In some aspects, the anode slurry has viscosity more than 1,000 mPa·s, more than 1,500 mPa·s, more than 2,000 mPa·s, more than 2,500 mPa·s, more than 3,000 mPa·s, more than 3,500 mPa·s, more than 4,000 mPa·s, more than 4,500 mPa·s, more than 5,000 mPa·s, or more than 5,500 mPa·s.

In some aspects, the anode slurries as disclosed herein exhibit shear thinning behavior, meaning the slurries have low viscosity at higher shear rates, and higher viscosity at lower shear rates. In some aspects, the shear rate experienced by the slurry during application to a substrate (i.e., during drawdown) is on the order of a range of about 100/s to about 200/s, for example about 167/s. Exemplary viscosities at various shear rates for formulations according to embodiments disclosed herein are provided in Table 4. In some aspects, the anode slurry has a viscosity in a range from about 1300 to about 1700 mPa·s at a shear rate of about 167/s. The viscosity at a specific shear rate is decreased with reduced concentrations of the carbon-silicon composite in the slurry. Accordingly, the desired viscosity may be achieved by, for example, adjusting the concentrations of the carbon-silicon composite in the slurry to reach the desired viscosity at the appropriate shear rate (e.g., in a range from about 1300 to about 1700 mPa·s at a shear rate of about 167/s). See, for example, the viscosity study disclosed herein within Example 1. In some aspects, the anode slurry has a viscosity at a shear rate of about 167/s of about 1300, about 1350, about 1400, about 1450, about 1500, about 1550, about 1600, about 1650, or about 1700 mPa·s.

In some aspects, the slurry comprises about 5% by weight of the carbon-silicon composite, and has a viscosity in a range from about 1100 to about 1700 at a shear rate in a range from about 200 to about 100/s. In some aspects, the slurry comprises about 10% by weight of the carbon-silicon composite, and has a viscosity in a range from about 1200 to about 2000 at a shear rate in a range from about 200 to about 100/s. In some aspects, the slurry comprises about 15% by weight of the carbon-silicon composite, and has a viscosity in a range from about 1300 to about 2100 at a shear rate in a range from about 200 to about 100/s.

### Anode Electrode Composition

In another aspect is provided an anode electrode composition comprising an anode material as described herein; a binder material as described herein; and a conductive material as described herein. Such compositions may be prepared by removing solvent from a slurry as described herein by evaporation at ambient or elevated temperatures. Such compositions may form an anode layer on a substrate as described further herein below.

The amount of anode material (i.e., the carbon-silicon composite and optionally, graphite) present in the anode electrode composition may vary. In some aspects, the anode electrode composition comprises the anode material in an amount by weight in a range from about 70 to about 90%, on a dry weight basis, based on the total weight of the anode electrode composition.

The amount of binder material present in the anode electrode composition may vary. In some aspects, the anode electrode composition comprises the binder material in an amount by weight in a range from about 2 to about 30%, or about 5 to about 15%, on a dry weight basis, based on the total dry weight of the anode electrode composition.

The amount of the conductive material present in the anode electrode composition may vary. In some aspects, the anode electrode composition comprises the conductive material in an amount by weight in a range from about 0.5 to about 20% on a dry weight basis, based on the total weight of the anode electrode composition.

### Lithium-Ion Battery Anode

In another aspect is provided a lithium-ion battery anode comprising an anode electrode layer dispersed on the anode substrate, wherein the anode electrode layer comprises the lithium-ion battery anode slurry as described herein, disposed on the anode substrate in the form of a dry film (i.e., the anode electrode composition as described herein above).

As a non-limiting example description, a lithium-ion battery anode as described herein is generally prepared by coating an anode slurry as described herein on a substrate to form a coated substrate; and drying the coated substrate to form the lithium-ion battery anode. In some aspects, the substrate is coated on one side. In some aspects, the substrate is coated on both sides.

The material of the substrate and the physical form of the substrate may vary. The anode substrate acts to collect electrons generated by electrochemical reactions of the battery electrode material or to supply electrons required for the electrochemical reactions. The substrate may be in the form of a foil, sheet, mesh, or film. The substrate thickness may vary. In some aspects, the substrate has a thickness, prior to coating, from about 5 μm to about 40 μm. The substrate may be formed of a conductive material such as stainless steel, titanium, nickel, aluminum, copper, or an electrically conductive resin. In some aspects, the substrate is a copper film.

In some aspects, the coating process is performed using a doctor blade coater, a slot-die coater, a transfer coater, a spray coater, a roll coater, a dip coater, or a curtain coater. The term “doctor blading” refers to a process for fabrication of large area films on rigid or flexible substrates. A coating thickness (i.e., of the anode slurry) can be controlled by an adjustable gap width between a coating blade and a coating surface (i.e., the substrate), which allows the deposition of variable wet layer thicknesses. The term “transfer coating” or “roll coating” refers to a process for fabrication of large area films on rigid or flexible substrates. A slurry is applied on the substrate by transferring a coating from the surface of a coating roller with pressure. A coating thickness can be controlled by an adjustable gap width between a metering blade and a surface of the coating roller, which allows the deposition of variable wet layer thicknesses. In a metering roll system, the thickness of the coating is controlled by adjusting the gap between a metering roller and a coating roller. In some aspects, the coating process is performed using a doctor blade with a blade gap height between 60 and 500 micrometers. In some aspects, the blade height is from about 60 to about 150 micrometers.

After coating the anode slurry on the substrate, the coated film disposed on the substrate can be dried by a dryer to obtain the anode. Any dryer that can dry the coated film can be used. Some non-limiting examples of suitable dryers are a batch drying oven, a box-type drying oven, a hot plate, a conveyor drying oven, a multi-zoned oven, and a microwave drying oven. Some non-limiting examples of a conveyor drying oven include a conveyor hot air-drying oven, a conveyor resistance drying oven, a conveyor inductive drying oven, and a conveyor microwave drying oven.

After drying the slurry coating, solvent has been removed from the anode slurry layer, providing the initial anode. In some aspects, the anode is compressed mechanically in order to enhance the density of the anode. Such compression may be performed by calendaring, which uses plates or rollers for compaction. The calendaring pressure may vary. In some aspects, a press density approximately equal to the press density of the anode material is applied. As used herein, the term “press density” refers to the density of the anode electrode after calendaring., computed by dividing the loading of the anode electrode (mg/cm²) by the thickness of the anode electrode coating (cm). Generally, anodes comprising an anode material in the form of a xerogel are compressed to about 0.7 to 2 g/cm³, while those comprising an anode material in the form of an aerogel are compressed to about 0.3 to 0.7 g/cm³.

Following the calendaring, the anode is then dried under vacuum with application of heat for a period of time. In some aspects, the anode is dried for a period of time from about 1 hour to about 24 hours, such as about 6 or about 12 hours. In some aspects, the temperature is from about 50, about 80, or about 100, to about 120, about 140, about 160, about 180, or about 200° C. In some aspects, the temperature is about 120° C.

The amount of anode material (i.e., the carbon-silicon composite and optionally, graphite) present in the anode electrode layer may vary. In some aspects, the lithium-ion battery anode comprises the anode material in an amount by weight in a range from about 75 to about 85%, on a dry weight basis, based on the total weight of the anode electrode layer.

The amount of binder material present in the anode electrode layer may vary. In some aspects, the lithium-ion battery anode electrode layer comprises the binder material in an amount by weight in a range from about 2 to about 20%, or about 5 to about 15%, on a dry weight basis, based on the total weight of the anode electrode layer.

The amount of the conductive material present in the anode electrode layer may vary. In some aspects, the lithium-ion battery anode electrode layer comprises the conductive material in an amount by weight in a range from about 0.5 to about 15% on a dry weight basis, based on the total weight of the anode electrode layer.

The thickness of the anode electrode layer may vary. In some aspects, the thickness of the anode electrode layer on the substrate is from about 10 μm to about 300 μm, or from about 20 μm to about 100 μm.

The coating density (i.e., loading) of the anode electrode layer, measured in mg/cm², may vary. For example, in some aspects, the coating density is from about 2.5 to about 7 mg/cm². In some aspects, the coating density is about 4 mg/cm². In some aspects, the coating density is about 6.9 mg/cm².

The press density of the anode electrode layer may vary. In some aspects, the press density is in a range from about 0.3 to about 0.7 g/cm³, or from about 0.7 to about 2 g/cm³.

In some aspects, the anode electrode layer has an areal capacity of about 3 to about 8 mAh/cm²

### Lithium-Ion Battery

In another aspect is provided a lithium-ion battery comprising an anode as described herein; a cathode; and a separator interposed between the cathode and the anode.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed. No language in the specification should be construed as indicating any non-claimed element as essential to the practice of the disclosed materials and methods.

It will be readily apparent to one of ordinary skill in the relevant arts that suitable modifications and adaptations to the compositions, methods, and applications described herein can be made without departing from the scope of any aspects. The compositions and methods provided are exemplary and are not intended to limit the scope of the claimed aspects. All of the various aspects and options disclosed herein can be combined in all variations. The scope of the compositions, formulations, methods, and processes described herein include all actual or potential combinations of aspects, options, examples, and preferences herein.

Although the technology herein has been described with reference to particular aspects, it is to be understood that these aspects are merely illustrative of the principles and applications of the present technology. It will be apparent to those skilled in the art that various modifications and variations can be made to the method and apparatus of the present technology without departing from the spirit and scope of the technology. Thus, it is intended that the present technology include modifications and variations that are within the scope of the appended claims and their equivalents.

Reference throughout this specification to “one aspect,” “certain aspects,” “one or more aspects” or “an aspect” means that a particular feature, structure, material, or characteristic described in connection with the aspect is included in at least one aspect of the technology. Thus, the appearances of phrases such as “in one or more aspects,” “in certain aspects,” “in one aspect” or “in an aspect” in various places throughout this specification are not necessarily referring to the same aspect of the technology. Furthermore, the particular features, structures, materials, or characteristics may be combined in any suitable manner in one or more aspects. Any ranges cited herein are inclusive.

All U.S. patent applications, published patent applications, and patents referred to herein are hereby incorporated by reference.

Aspects of the present technology are more fully illustrated with reference to the following examples. Before describing several exemplary aspects of the technology, it is to be understood that the technology is not limited to the details of construction or process steps set forth in the following description. The technology is capable of other aspects and of being practiced or being carried out in various ways. The following examples are set forth to illustrate certain aspects of the present technology and are not to be construed as limiting thereof.

### EXEMPLIFICATION

The present invention may be further illustrated by the following non-limiting examples describing the methods.

### Example 1. Preparation of Carbon-Silicon Composite/Graphite Anodes

Battery anodes comprising a carbon-silicon composite and graphite were prepared according to the following general procedure.

Carboxymethylcellulose powder (CMC; MAC500) was dissolved in water to form a solution having a solids content of 1.5% by weight. For large batches, the CMC and water were mixed overnight using an overhead mixer. For small batches, the CMC and water were mixed for 15 minutes at 2500 rpm, allowed to stand overnight, and mixed again for 5 minutes at 2500 rpm before use. The solution was added to a Flacktek cup, followed by carbon black (Timcal Super C65; Imersys SA, Paris, France). The slurry was mixed for 5 minutes at 2500 rpm or until a homogenous slurry was produced. The carbon-silicon composite (50% silicon; target density of 0.085 g/cm³; prepared according to the method described in Example 11 of U.S. Patent Application Publication No. 2020/0269207 to Zafiropoulos et al.) and graphite (GHDR-14; Imersys SA, Paris, France) were added along with a portion (approximately one third to two thirds) of the total volume of water to be used in the final slurry. The total volume of water is calculated based on the BET surface area of the slurry components and the desired solids content (generally 30 to 60% solids content by weigh, based on the total weight of the slurry. Slurry components with a high surface area require more water to provide the desired rheological properties of the slurry. The remaining water was added as necessary to provide the required viscosity. An aqueous emulsion of 40 wt % styrene-butadiene rubber (SBR; Zeon Chemicals, Louisville, KY) was added to the slurry and mixed for about 1 minute at 2000 rpm while avoiding significant frictional heating.

Using this general method, several slurries were prepared with the components and quantities by weight, on a dry weight basis, provided in Tables 1, 2, and 3.

TABLE 1
Carbon-Silicon Composite/Graphite Anode Slurry
Formulation 1 (10:90 blend of active/graphite)

| | | Weight % in slurry |
|---|---|---|
| Component | Type | (dry weight basis) |
| Rheology modifier | Carboxymethylcellulose 500 | 2 |
| C/Si composite | Surface area of 13 m²/g; tap | 9.4 |
| | density of 0.53 g/cm³; silicon | |
| | content 50 wt % | |
| Conductive Additive | Carbon black | 1 |
| Graphite | GHDR-14 | 84.6 |
| Binder | styrene-butadiene rubber; | 3 |
| | 0.4% aq. suspension | |

TABLE 2
Carbon-Silicon Composite/Graphite Anode Slurry
Formulation 2 (15:85 blend of active/graphite)

| | | Weight % in slurry |
|---|---|---|
| Component | Type | (dry weight basis) |
| Rheology modifier | Carboxymethylcellulose 500 | 2 |
| C/Si composite | Surface area of 13 m²/g; tap | 14 |
| | density of 0.53 g/cm³; silicon | |
| | content 50 wt % | |
| Conductive Additive | Carbon black | 1 |
| Graphite | GHDR-14 | 80 |
| Binder | styrene-butadiene rubber; | 3 |
| | 0.4% aq. suspension | |

TABLE 3
Carbon-Silicon Composite/Graphite Anode Slurry
Formulation 3 (5:95 blend of active/graphite)

| | | Weight % in slurry |
|---|---|---|
| Component | Type | (dry weight basis) |
| Rheology modifier | Carboxymethylcellulose 500 | 2 |
| C/Si composite | Surface area of 13 m²/g; tap | 5 |
| | density of 0.53 g/cm³; silicon | |
| | content 50 wt % | |
| Conductive Additive | Carbon black | 1 |
| Graphite | GHDR-14 | 90 |
| Binder | styrene-butadiene rubber; | 3 |
| | 0.4% aq. suspension | |

A viscosity study was performed on each of the slurry formulations of Tables 1, 2, and 3. The viscosities at various shear rates for the three formulations is provided in Table 4. With reference to Table 4, the study indicated that the slurries are shear-thinning (i.e., exhibiting lower viscosity at higher shear rate and higher viscosity at lower shear rate), and that the lower the amount of active in the blend, the lower the viscosity (formulations 2, 1, and 3, in decreasing order). The viscosities at a shear rate of 167 are particularly relevant, as this approximates the shear rate observed during drawdown when the slurry is being applied to the substrate.

TABLE 4
Viscosity Study Results

| Shear rate | Formulation 3 | Formulation 1 | Formulation 2 |
|---|---|---|---|
| (1/s) | (cP) | (cP) | (cP) |
| 1 | 24762.2 | 25515.5 | 35210.3 |
| 2 | 18268.4 | 18916.2 | 24548.2 |
| 5 | 11903.2 | 12595.7 | 15489.9 |
| 10 | 7490.7 | 7992.6 | 9365.1 |
| 22 | 4628.4 | 4975.4 | 5682.7 |
| 46 | 2842.8 | 3069.8 | 3449.2 |
| 100 | 1734.3 | 1879.7 | 2091.5 |
| 167 | 1309.7 | 1422 | 1577.9 |
| 200 | 1100.7 | 1196.9 | 1324.9 |

The prepared slurries were each separately cast on copper foil using a doctor blade with a blade gap height between 60 and 150 micrometers. The coated copper foils were dried in air under ambient conditions on small scale, or in a zoned drying oven at temperatures from about 80 to about 100° C. The resulting anodes were calendared to a press density approximately equal to the tap density of the anode material. Generally, anodes comprising an anode material in the form of a xerogel were compressed to about 0.7 to 1.1 g/cm³ while those comprising an aerogel anode material were compressed to about 0.3 to 0.7 g/cm³. Following the calendaring, the anodes were dried under vacuum for 12 hours at 120° C.

### Example 2. Preparation of Carbon-Silicon Composite Anodes

Battery anodes comprising a carbon-silicon composite were prepared according to the following general procedure.

Polyacrylic acid (PAA) was dissolved in water to form a solution having a solids content of 10% by weight. The solution was added to a Flacktek cup, followed by carbon black (Timcal Super C65). The slurry was mixed for 5 minutes at 2500 rpm or until a homogenous slurry was produced. The carbon-silicon composite (as in Example 1; prepared according to the method described in Example 11 of U.S. Patent Application Publication No. 2020/0269207 to Zafiropoulos et al.) was added along with a portion (approximately two thirds) of the total volume of water to be used in the final slurry. The remaining water was added as necessary to provide the required viscosity, and the slurry mixed for about 5 minutes at 2500 rpm. Using this general method, several slurries were prepared with the components and quantities by weight, on a dry weight basis, provided in Table 5.

TABLE 5
C/Si Anode Slurry Compositions

| | | Carbon-silicon | | Carbon black, |
|---|---|---|---|---|
| | | composite % by | Polyacrylic acid, | % by weight |
| | Carbon-silicon | weight (dry | % by weight (dry | (dry weight |
| Example # | composite form | weight basis) | weight basis) | basis) |
| 2A | xerogel (<100 m²/g) | 80 | 10 | 10 |
| 2B | aerogel (<100 m²/g) | 80 | 10 | 10 |
| 2C | aerogel (>100 m²/g) | 75 | 15 | 10 |

The resulting slurries were individually cast on copper foil using a doctor blade with a blade gap height between 60 and 150 micrometers. The coated copper foil was dried in air under ambient conditions on small scale, or in a zoned drying oven at temperatures from about 80 to about 100° C. The resulting anode was calendared to 1.6-1.7 g/cm³, followed by drying under vacuum for 12 hours at 120° C.

### Example 3. Preparation of Carbon-Only Anodes (Reference)

Battery anodes comprising soft carbon only were prepared according to the following general procedure.

Carboxymethylcellulose powder (CMC; MAC500) was dissolved in water to form a solution having a solids content of 1.5% by weight. The solution was added to a Flacktek cup, followed by carbon black (Timcal Super C65). The slurry was mixed for 5 minutes at 2500 rpm or until a homogenous slurry was produced. Soft carbon was added along with the total volume of water to be used in the final slurry. An aqueous emulsion of styrene-butadiene rubber (SBR) was added to the slurry and mixed for about 1 minute at 2000 rpm while avoiding significant frictional heating.

Using this general method, several slurries were prepared with the components and quantities by weight, on a dry weight basis, provided in Tables 6, 7, and 8.

TABLE 6
Low (<100 m²/g) Surface Area Carbon Only Formulation #1

| | | Weight % in slurry |
|---|---|---|
| Component | Type | (dry weight basis) |
| Rheology modifier | Carboxymethylcellulose 500 | 2 |
| Conductive Additive | Carbon black | 2 |
| Active Material | Low surface area | 93 |
| | Carbon; <100 m²/g | |
| Binder | styrene-butadiene rubber; | 3 |
| | 0.4% aq. suspension | |

TABLE 7
Low (<100 m²/g) Surface Area Carbon Only Formulation #2

| | | Weight % in slurry |
|---|---|---|
| Component | Type | (dry weight basis) |
| Rheology modifier | Carboxymethylcellulose 500 | 2 |
| Conductive Additive | Carbon black | 1 |
| Active Material | Low surface area | 94 |
| | Carbon; <100 m²/g | |
| Binder | styrene-butadiene rubber; | 3 |
| | 0.4% aq. suspension | |

TABLE 8
High (>100 m²/g) Surface Area Carbon Only Formulation #1

| | | Weight % in slurry |
|---|---|---|
| Component | Type | (dry weight basis) |
| Rheology modifier | Carboxymethylcellulose 500 | 3.5 |
| Conductive Additive | Carbon black | 2 |
| Active Material | High surface area | 90 |
| | Carbon; >100 m²/g | |
| Binder | styrene-butadiene rubber; | 4.5 |
| | 0.4% aq. suspension | |

The resulting slurries were individually cast on copper foil using a doctor blade with a blade gap height between 60 and 150 micrometers. The coated copper foil was dried in air under ambient conditions on small scale, or in a zoned drying oven at temperatures from about 80 to about 100° C. The resulting anode was calendared to a press density approximately equal to the press density of the soft carbon, followed by drying under vacuum for 12 hours at 120° C.

### Example 4. Alternative Preparation of Carbon-Silicon Composite/Graphite Anodes

Battery anodes comprising a carbon-silicon composite and graphite were prepared according to the following general procedure.

Carboxymethylcellulose powder (CMC; MAC500; 1.33 g) was dissolved in water by mixing for 15 minutes at 2500 rpm to form a solution having a solids content of 10% by weight. The solution was added to a Flacktek cup, followed by carbon black (0.1 g; Timcal Super C65; Imersys SA, Paris, France). The slurry was mixed for 5 minutes at 2500 rpm. Graphite (0.74 g; GHDR-14; Imersys SA, Paris, France) was added and the slurry was mixed for 5 minutes at 2500 rpm. A portion of the carbon-silicon composite (one half of the total amount; 0.093 g; 50% silicon; target density of 0.085 g/cm³; prepared according to the method described in Example 11 of U.S. Patent Application Publication No. 2020/0269207 to Zafiropoulos et al.) was added and the slurry was mixed for 5 minutes at 2500 rpm. The remaining half of the carbon-silicon composite (0.093 g) was added and the slurry was mixed for 5 minutes at 2500 rpm. An aqueous emulsion of 40 wt % styrene-butadiene rubber (SBR; Zeon Chemicals, Louisville, KY) was added to the slurry in a quantity to provide 75 mg of the SBR and mixed for 5 minutes at 2500 rpm.

The resulting slurry was cast on copper foil using a doctor blade with a blade gap height between 60 and 150 micrometers at a press density of 2 g/cm³ and a loading of 6.9 mg/cm². The coated copper foil was dried in air under ambient conditions, followed by drying under vacuum for 12 hours at 120° C. The coating thickness was 30 micrometers, and the coating mass was 0.82 mg. Compared to the coated foils of Example 1, this alternative procedure provided a more uniform and higher density coating layer.

What is claimed is:

1. An anode electrode composition comprising:
from about 75 to about 90% by weight of an anode active material comprising a carbon-silicon composite having a BET surface area by N2 adsorption in a range from about 3 to about 75 m²/g;
from about 2 to about 20% by weight of a binder material selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, cyanoethylsucrose, fluorinated polymer, chlorinated polymer, a salt of alginic acid, polyvinylidene fluoride, poly(vinylidene fluoride)-hexafluoropropene, and combinations thereof; and
from about 0.5 to about 15% by weight of a conductive material;
wherein all percent by weight values are on a dry weight basis and are based on the total weight of the composition.

2. The anode electrode composition of claim 1, wherein the anode active material further comprises graphite.

3. The anode electrode composition of claim 1, wherein the anode active material comprises a ratio of about 80 wt % carbon active material to about 20 wt % carbon-silicon composite.

4. The anode electrode composition of claim 1, wherein the carbon-silicon composite comprises silicon in a range from about 20% by weight to about 85% by weight, based on the total weight of the carbon-silicon composite.

5. The anode electrode composition of claim 1, wherein the silicon in the carbon-silicon composite is present in particulate form, the particles having an average particle size of about 1 μm or less.

6. The anode electrode composition of claim 1, wherein the carbon-silicon composite is an aerogel, a xerogel, a cryogel, or an ambigel.

7. The anode electrode composition of claim 1, wherein the carbon-silicon composite comprises a carbonized polyimide aerogel.

8. The anode electrode composition of claim 1, wherein the carbon-silicon composite comprises a pore structure, the pore structure comprising a fibrillar morphology and an array of pores surrounding elemental silicon.

9. The anode electrode composition of claim 1, wherein the carbon-silicon composite has a tap density in a range from about 0.3 g/cm³ to about 1.3 g/cm³.

10. The anode electrode composition of claim 1, wherein the carbon-silicon composite has a specific capacity of at least 400 mAh/g.

11. The anode electrode composition of claim 1, wherein the conductive material is selected from the group consisting of carbon, carbon black, carbon fibers, carbon nano-fibers, graphitized carbon flake, carbon tubes, carbon nanotubes, activated carbon, mesoporous carbon graphene, graphene oxide, graphene nanoplatelets, and combinations thereof.

12. The anode electrode composition of claim 1, wherein the binder material is styrene-butadiene rubber, the anode electrode composition further comprising a rheology modifier which is a cellulose ether.

13. The anode electrode composition of claim 12, wherein the rheology modifier is carboxymethyl cellulose.

14. An anode for a lithium-ion battery, the anode comprising:
an anode substrate; and
an anode electrode layer disposed on the anode substrate, wherein the anode electrode layer comprises the anode electrode composition of claim 1.

15. The anode of claim 14, wherein the substrate is a copper film.

16. The anode of claim 14, wherein the anode electrode layer is loaded on the substrate at a density from 2.5 to about 4.5 mg/cm².

17. The anode of claim 14, wherein the anode electrode layer is from about 10 μm to about 300 μm in thickness.

18. The anode of claim 14, wherein a press density of the anode electrode layer is in a range from about 0.3 to about 1.1 g/cm³.

19. The anode of claim 14, wherein an areal capacity of the anode electrode layer is 4.5-5.5 mAh/cm².

20. The anode of claim 14, wherein a conductivity of the anode electrode layer is at least about 10 S/cm.

21. A lithium-ion battery comprising:
a cathode;
the anode of claim 14; and
a separator interposed between the cathode and the anode.

22. A slurry for preparation of a lithium-ion battery anode, the slurry having a viscosity in a range from about 500 mPa·s to about 3500 mPa·s at a shear rate from about 100/s to about 200/s, the slurry comprising:
75-90% by weight of an anode active material comprising a carbon-silicon composite having a BET surface area by N2 adsorption in a range from about 3 to about 75 m²/g;
5-15% by weight of a binder material selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, cyanoethylsucrose, fluorinated polymer, chlorinated polymer, a salt of alginic acid, polyvinylidene fluoride, poly(vinylidene fluoride)-hexafluoropropene, and combinations thereof;
1-10% by weight of a conductive material; and
a solvent;
wherein all percent by weight values are on a dry weight basis and are based on the total weight of the slurry after removal of the solvent.

23. A process for preparing a lithium-ion battery anode slurry, the process comprising:
providing an anode material, a binder material, a conductive material, and a solvent; and
combining the anode material, the binder material, and the conductive material in the solvent, wherein the slurry is a homogenous dispersion having a viscosity in a range from about 500 mPa·s to about 3500 mPa·s at a shear rate from about 100/s to about 200/s, and wherein:
a solids content of the slurry is in a range from about 30 to 60% by weight, based on the total weight of the slurry; and
the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, polyester, polyamide, polyether, polyimide, polycarboxylate, polycarboxylic acid, polyacrylic acid, lithiated polyacrylic acid, ammonia polyacrylic acid, polyacrylate, polymethacrylic acid, polymethacrylate, polyacrylamide, polyurethane, cyanoethylsucrose, fluorinated polymer, chlorinated polymer, a salt of alginic acid, polyvinylidene fluoride, poly(vinylidene fluoride)-hexafluoropropene, and combinations thereof.
